(19) United States
(12) Patent Application Publication
(10) Pub. No.: US 2008/0103873 A1
(43) Pub. Date: May 1, 2008

(54) Method of stimulating business development of neighborhood communities

(76) Inventor: Keith Clarke, East Orange, NJ (US)

Correspondence Address: Anna Vishev, Esq.;Wolff & Samson PC, One Boland Drive, West Orange, NJ, 07052, US

(21) Appl. No.: 11/586,146

(22) Filed: Oct. 25, 2006

(51) Int. Cl. G07G 1/00

(52) U.S. Cl. 705/10

(57) ABSTRACT

The present invention provides a method of stimulating business development of neighborhood communities, accomplished by identifying a common aspect of target neighborhood communities, developing a brand related to the identified common aspect of the target communities, providing means for connecting these target communities using the developed brand; and utilizing the above connecting means as a source of information, products and/or business opportunities for members of the target communities.

### BACKGROUND

The invention relates to a method of community-based business development.

Over the past 30 years, a new model of inner-city economic development has emerged in the United States—community-based development. Its basic premise is that poverty can be defeated by investing in the future of low- and moderate-income people in the communities where they live, rather than by trying to disperse them to other, higher income areas. Practitioners of community-based development recognize that, even in very low-income communities, there are hardworking people, social and kinship networks, and churches and other civic organizations that constitute valuable human resources upon which a vibrant, inner-city community can be rebuilt. And despite low average household incomes, many inner-city communities are large enough to be lucrative markets for retail goods and services. Moreover, their central locations in metropolitan areas make most inner-city neighborhoods potential candidates for the location of small, ancillary businesses that supply larger industries in the metropolitan economy.

The community-based development model seeks to realize such economic potentials of inner-city neighborhoods through partnerships of private investors, government, and nonprofit organizations. The community-based development approach is usually centered around a community development corporation, or CDC. A typical CDC is a nonprofit organization that is both market-oriented and dedicated to serving the residents of the neighborhood where it is located. Its base in the neighborhood affords it a unique understanding of local market conditions and opportunities for new investment. With this knowledge and with the support of neighborhood residents, a savvy CDC can access public and nonprofit foundation funding to leverage private financing of profitable investments in housing and small businesses. CDCs help to create a positive overall business climate. Because they know the residents well, they sometimes can address social problems like crime more effectively than local government can, and they can provide a point of access for residents to job training and social services. Thus, a good CDC can serve as a grassroots-based partner of both private investors and local government.

Changes in the regulatory climate also helped to stimulate community-based development. Congressional passage of the Home Mortgage Disclosure Act in 1975, the Community Reinvestment Act in 1977, and amendments to the Financial Institutions Reform, Recovery and Enforcement Act (FIRREA) IN 1989 challenged lenders to invest more capital in inner-city areas. In response, many financial institutions created community-lending departments with staff and resources dedicated to community development. Other financial institutions facilitated community lending by creating low-cost capital pools. Examples include the Federal Home Loan Bank's Affordable Housing Program and its Community Investment Program. These programs offer member banks long-term, fixed rate capital so that they can make longer term loans than they otherwise could, and at lower interest rates than they would otherwise need to charge.

Notwithstanding these significant achievements, however, conditions in many central-city neighborhoods are not improving. If the problem of persistent, inner-city poverty is to be effectively addressed, more creative approaches to the community-based development must be devised and implemented.

### BRIEF SUMMARY

In general, in a first aspect, the invention features a method of stimulating business development of neighborhood communities, accomplished by identifying a common aspect of target neighborhood communities, developing a brand related to the identified common aspect of the target communities, providing means for connecting these target communities using the developed brand; and utilizing the above connecting means as a source of information, products and/or business opportunities for members of the target communities.

Business development of the target communities may be further accelerated by licensing the developed brand to businesses within these communities. Additionally, business opportunities developed as a result of implementing the above method may be merged across several target communities based on the developed brand. Finally, various business networks may be created based on the developed brand.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1 is a schematic flow chart showing steps to be performed in order to accomplish the method of the present invention.

### DETAILED DESCRIPTION

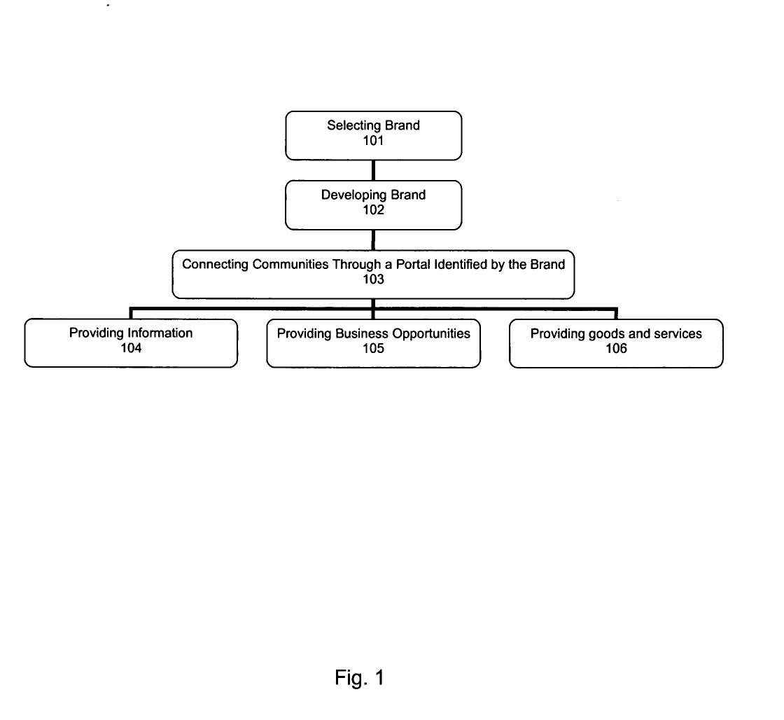

As shown in FIG. 1, in the preferred embodiment, the method of stimulating business development of neighborhood communities is accomplished by first selecting (Step 101) and developing (Step 102) a brand and then using the developed brand to connect these communities (Step 103) and to provide information (Step 104), business opportunities (Step 105), goods and services (Step 106) to members of these communities.

In accordance with Step 101, in order to select a brand which is appropriate for use with the present invention, it is first necessary to identify at least one common aspect of the target neighborhood communities. For example, inner city communities are sometimes referred to as “hoods.” Therefore, the term “hood” by itself or in combination with other words and/or phrases is a good candidate for a brand to be used with the present invention to stimulate growth and business development in such inner city communities.

Following the step of selection, the brand is built up, in accordance with Step 102. The brand may be developed by using it in connection with consumer products, information services, entertainment products, retail outlets, Internet sites and other similar products and/or services offered to members of target communities. To further develop the selected brand, it may be registered as a federal and/or state trademark/service mark. Any other conventionally known marketing technique, e.g. target advertising, promotion, publicity, etc., may also be used for brand development.

In accordance with Step 103, the selected brand is next used to connect the target neighborhood communities by providing a connecting forum identified by the brand. For example, if the selected brand is “hoodlove,” the connecting forum for inner city communities may be a website “hoodlove.com.” A person skilled in the art would understand that Steps 102 and 103 may be performed simultaneously.

In accordance with Steps 103-106 of the preferred embodiment of the present invention, the connecting forum is an Internet portal connecting target neighborhood communities and providing its members with information, business opportunities, goods and services.

Specifically, in the preferred embodiment, the Internet portal provides a business directory which lists and ranks business entities operating within target communities. Each listing preferably includes a location map and directions to this location that a user may selectively access. A community survey is provided on the Internet portal to be filled out by target community members to identify businesses to be included in the directory. Businesses are selected for the directory based on their location, the volume of business they are doing within target communities and rating assigned to a particular business by members of target communities. In addition to the business directory, the Internet portal provides information on businesses popular and useful to target communities, information about community events or events outside a particular community that may be of interest to its members, legal and health care information, message boards, discussion forums, etc.

Further, the provided Internet portal serves as a source of new business opportunities. For example, the above described business directory not only identifies existing businesses but also points out specific business opportunities when a particular business is not found in a selected target community. Additionally, the portal provides financing and business support services and information to new and established businesses. For example, it may research and list new venues for existing businesses or franchises, publish reviews for existing businesses and provide demographic information to businesses contemplating opening in a particular community. The portal also facilitates business-to-business connections between businesses located throughout target communities. Additional business opportunities may be created by providing franchising and licensing options and by listing employment openings on the portal.

In addition to being a source of business information, the Internet portal provides a venue for social interactions between members of target communities. Such social interaction is facilitated through use of monitored chat rooms, message boards and real-time debates on topics of interest to the communities. The portal may periodically offer a writing contest and an art contest to find and encourage talented writers and artists within target communities. It may also host fundraising events to generate financial resources for particular community-benefiting projects.

As a result of activities described above, the Internet portal generates a network of target communities-related businesses linked by the selected and established brand through the Internet portal. This network may then be utilized to improve the quality of life in target communities. For example, businesses within this network may offer job opportunities through the network first to members of target communities. Further, successful businesses may brunch out into a new target community area based on the information and support they receive through the network. Similarly, low cost housing development in a particular target area may be encouraged by using the network to provide reliable demographic information to interested developers.

Once the brand is sufficiently established and recognized in target communities, and the Internet portal becomes a central business development tool and a social interaction venue for these communities, communities development may be further stimulated by opening cyber cafes, entertainment and recreational plazas and stores identified by the same brand. Further, a magazine dedicated to the issues of the same target communities and identified by the same established brand may be published. All of these activities will further stimulate job creation and business development within target communities.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

The invention claimed is:

1. A method of stimulating business development of neighborhood communities, comprising the steps of:
identifying a common aspect of said neighborhood communities;
developing a brand related to said identified common aspect of said neighborhood communities;
providing means for connecting said neighborhood communities using said developed brand; and
utilizing said means for connecting said neighborhood communities as a source of at least one of information, products and business opportunities for members of said neighborhood communities.

2. The method of stimulating business development according to claim 1, wherein said step of providing means for connecting said neighborhood communities further comprises a step of setting up an Internet portal identified by said developed brand.

3. The method of stimulating business development according to claim 2, wherein said step of setting up said Internet portal further includes a step of providing a business directory.

4. The method of stimulating business development according to claim 2, wherein said step of setting up said Internet portal further includes a step of providing an on-line survey of local businesses.

5. The method of stimulating business development according to claim 2, wherein said Internet portal serves as a source of business opportunities within said neighborhood communities.

6. The method of stimulating business development according to claim 2 further comprising a step of facilitating business-to-business connections between business entities located in said neighborhood communities.

7. The method of stimulating business development according to claim 2, wherein said step of setting up said Internet portal further includes a step of providing a venue for social interactions between members of said neighborhood communities.

8. The method of stimulating business development according to claim 1, further comprising the step of licensing said developed brand to businesses within said neighborhood communities.

9. The method of stimulating business development according to claim 1, further comprising the step of merging business opportunities across said neighborhood communities based on said developed brand.

10. The method of stimulating business development according to claim 1, further comprising the step of advertising said developed brand in said neighborhood communities.

11. The method of stimulating business development according to claim 1, further comprising the step of developing business networks based on said developed brand.

12. The method of stimulating business development according to claim 1, wherein said step of developing said brand further comprises a step of registering said brand as a trademark.
